(19) United States
(12) Patent Application Publication
(10) Pub. No.: US 2006/0027075 A1
(43) Pub. Date: Feb. 9, 2006

(54) Tuning device for musical instrument, musical instrument, knob, and winding tool

(75) Inventor: Shinjiro Hirayama, Nagoya (JP)

Correspondence Address: OSTROLENK FABER GERB & SOFFEN, 1180 AVENUE OF THE AMERICAS, NEW YORK, NY, 100368403, US

(73) Assignee: Hoshino Gakki Co., LTD.

(21) Appl. No.: 11/068,325

(22) Filed: Feb. 28, 2005

(30) Foreign Application Priority Data
Aug. 3, 2004 (JP) 2004-227129

(51) Int. Cl. G10G 7/02

(52) U.S. Cl. 84/455

(57) ABSTRACT

A tuning device for use with a guitar. The tuning device has a knob including a large diameter portion and a small diameter portion, which are cylindrical and have different diameters. The small and large diameter portions are coaxial with each other. The large diameter portion is located closer to the head of the guitar than the small diameter portion. The large diameter portion has a peripheral surface defining a fine adjustment portion. The small diameter portion has a peripheral surface defining a quick winding portion. The fine adjustment portion and the quick winding portion enable efficient and facilitated tuning.

### BACKGROUND OF THE INVENTION

The present invention relates to a tuning device for a musical instrument, a musical instrument, a knob, and a winding tool.

A winding type tuning device used to adjust the tension of a string for a musical instrument, such as a guitar, is known in the prior art. As shown in FIG. 6, a typical tuning device 41 includes a knob 42, a housing 43 to which the knob 42 is attached, and a winding pin 44 projecting from the housing 43. A worm (not shown), which is connected to the knob 42, and a worm wheel (not shown), which is connected to the winding pin 44, are arranged in the housing 43. The worm and worm wheel are meshed with each other to form a known worm screw mechanism. The knob 42 is turned to rotate the winding pin 44 with the worm screw mechanism. The turning of the knob 42 adjusts the tension of a string.

The knob 42 of the tuning device 41 is plate-shaped so that it can easily be held between one's fingers. However, the position of one's finger must be changed in accordance with the angular position of the knob 42 when performing daily tuning. Thus, the torque applied to the knob 42 changes depending on where the knob 42 is held by one's fingers. This makes it difficult to finely adjust the tension of the string.

Further, when replacing a string with a new one, the new string is wound around the winding pin 44 a number of times. Thus, the knob 42 must be turned many times. However, with the plate-shaped knob 42, each time the knob 42 is turned by about 180 degrees, the wrist must be turned back to re-grip the knob 42 with one's finger. Thus, the changing of strings is extremely burdensome.

To solve these problems, U.S. Pat. No. 5,696,341 describes a cylindrical tuning device. The force applied to a knob of the tuning device remains almost the same when turned by fingers. Further, whenever the knob is turned by about 180 degrees, one's fingers do not have to re-grip the knob. Thus, the winding of a string for many times is not burdensome.

However, the tuning device of the above patent has the shortcomings described below.

Tuning is performed to adjust the key in an extremely fine manner. When the diameter of the knob is small, a great force is necessary to turn the knob. In addition, the wound amount of the string changes greatly just by slightly turning the knob. It is thus preferable that the knob have a sufficient size. To enable the tension of a string to be finely adjusted, a typical cylindrical knob has a diameter of approximately 15 to 18 mm.

However, when the diameter of the knob is approximately 15 to 18 mm, the knob itself is large. This narrows the interval between knobs since knobs are arranged in a row on the head of a musical instrument.

A guitar includes six strings and a tuning device for each string. A guitar may have three tuning devices arranged on each side of the head or six tuning devices arranged on one side of the head. The interval between tuning devices when there are six tuning devices on one side of the head is narrower compared to when there are three tuning devices on one side of the head. Thus, when the knob of the tuning device described in U.S. Pat. No. 5,696,341 is employed in a guitar having six tuning devices arranged on one side of the head, the large knob makes it difficult to perform tuning since one's fingers would be interfered with by a neighboring knob. This would lengthen the time required for tuning.

### SUMMARY OF THE INVENTION

It is an object of the present invention to provide a tuning device for a musical instrument, a musical instrument, a knob for a tuning device of a musical instrument, and a winding tool for turning the knob that enable efficient and facilitated tuning.

One aspect of the present invention is a tuning device for tuning a musical instrument having a string. The tuning device includes a winding pin for winding an end of the string. A knob is connected to the winding pin. The knob is turned to rotate the winding pin and tune the instrument. The knob includes a peripheral surface and an axis. A first operation portion is defined on the peripheral surface of the knob. A second operation portion is defined on the peripheral surface of the knob and arranged coaxial to the first operation portion. The first operation portion is arranged closer to the winding pin than the second operation portion. Distance between the first operation portion and the axis of the knob is greater than that between the second operation portion and the axis of the knob.

Another aspect of the present invention is a musical instrument including at least one string and a tuning device. The tuning device includes a winding pin for winding an end of the string. A knob is connected to the winding pin. The knob is turned to rotate the winding pin for tuning. The knob includes a peripheral surface and an axis. A first operation portion is defined on the peripheral surface of the knob. A second operation portion is defined on the peripheral surface of the knob and arranged coaxial to the first operation portion. The first operation portion is arranged closer to the winding pin than the second operation portion. Distance between the first operation portion and the axis of the knob is greater than that between the second operation portion and the axis of the knob.

A further aspect of the present invention is a knob for a tuning device for tuning a musical instrument having a string. The tuning device includes a winding pin for winding an end of the string. The knob is connectable to the winding pin for rotating the winding pin and adjusting string tension. The knob includes a peripheral surface and an axis. A first operation portion is defined on the peripheral surface of the knob. A second operation portion is defined on the peripheral surface and arranged coaxial to the first operation portion. The first operation portion is arranged closer to the winding pin than the second operation portion. Distance between the first operation portion and the axis is greater than that between the second operation portion and the axis.

Another aspect of the present invention is a winding tool for use with a tuning device for tuning a musical instrument having at least one string. The tuning device includes a winding pin for winding an end of the string, and a knob, connected to the winding pin. The knob has an axis, in which the knob is turned to rotate the winding pin and adjust string tension. The tuning device includes a cylindrical large diameter portion arranged on the knob. The large diameter portion has a peripheral surface. A cylindrical small diameter portion is arranged on the knob and has a diameter that is smaller than that of the large diameter portion. The small diameter portion has a peripheral surface. A first operation portion is defined on the peripheral surface of the large diameter portion. A second operation portion is defined on the peripheral surface of the small diameter portion and arranged coaxial to the first operation portion. The first operation portion is arranged closer to the winding pin than the second operation portion. Distance between the first operation portion and the axis of the knob is greater than that between the second operation portion and the axis of the knob. A plurality of holes are formed in the large diameter portion and extend parallel to the axis of the knob. The winding tool includes a support having projections that are respectively insertable into the holes of the large diameter portion. The winding tool also includes a handle for manually grasping. A connector connects the projections and the handle for forming a crank. The handle is operated in a state in which the projections are inserted into the corresponding holes to rotate the support and the knob integrally with each other.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a tuning device of a guitar according to a preferred embodiment of the present invention;

FIG. 2 is a perspective view showing the tuning device;

FIG. 3a is a perspective view showing a knob from above;

FIG. 3b is a perspective view showing the knob from below;

FIG. 4 is an exploded diagram showing an attachment structure of a knob;

FIG. 5 is a perspective view showing a winding tool; and

FIG. 6 is a perspective view showing a tuning device of the prior art.

### DETAILED DESCRIPTION OF THE PREFERRED EMBODIMENTS

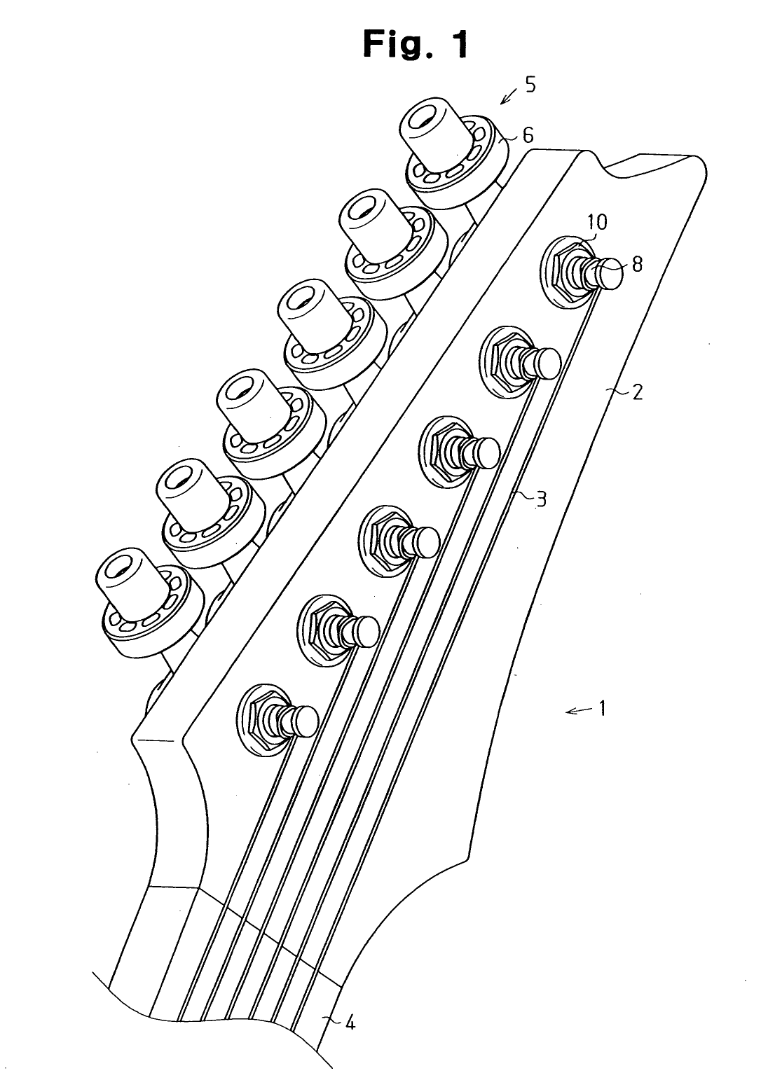

A tuning device of a guitar, which serves as a musical instrument, a knob, and a winding tool according to a preferred embodiment of the present invention will now be discussed with reference to FIGS. 1 to 5.

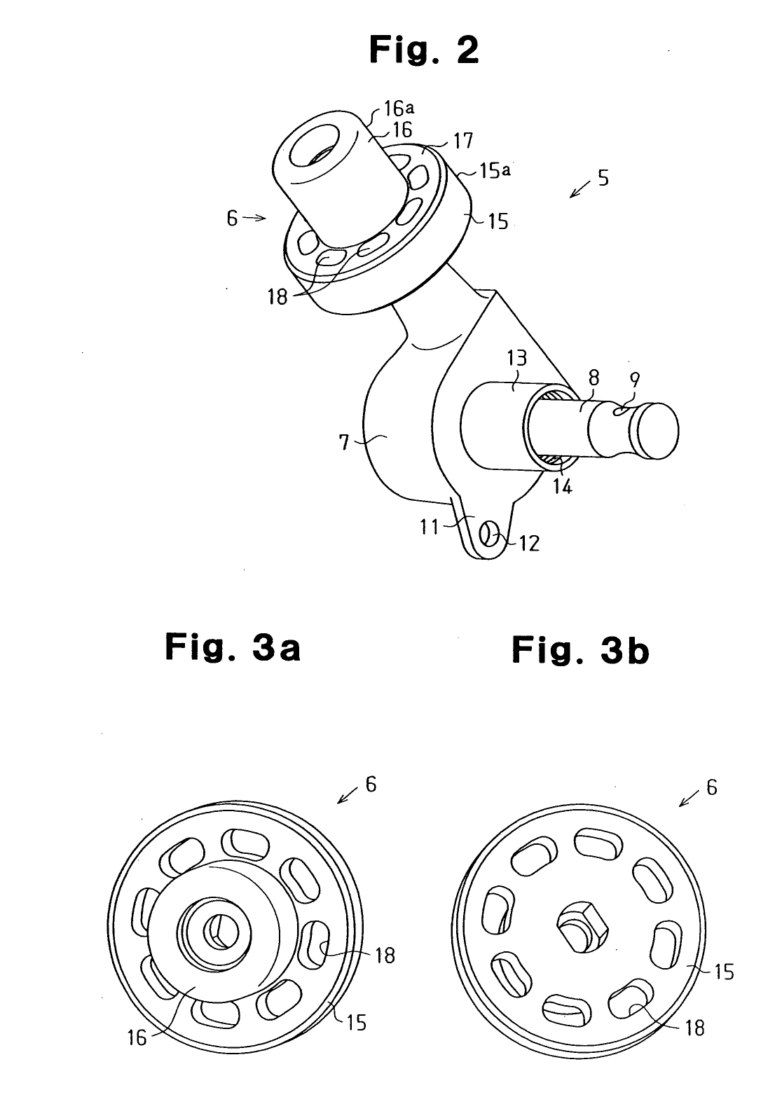

Referring to FIG. 1, a guitar 1 has a head 2, which extends from a neck 4 that is connected to a body (not shown). Six tuning devices 5, each for winding the end of one of six strings 3, are arranged in a row along the head 2. Referring to FIG. 2, each tuning device 5, which is referred to as a peg, includes a knob 6, a housing 7 to which the knob 6 is attached, and a winding pin 8. A sleeve 13 projects from the front surface of the housing 7. The winding pin 8 projects frontward out of the sleeve 13. A female thread 14 is formed in the sleeve 13. A string hole 9 extends through the front end of the winding pin 8. Referring to FIG. 1, the end of a string 3 is inserted through the string hole 9 and wound around the winding pin 8 a number of times.

A worm 7a, which is connected to the knob 6, and a worm wheel 7b, which is connected to the winding pin 8, are arranged in each housing 7. The worm 7a and worm wheel 7b mesh with each other to form a worm screw mechanism 7c, which is known in the art. Thus, when the knob 6 is turned in the forward direction or the reverse direction, the worm screw mechanism 7c rotates the winding pin 8. Accordingly, the tuning device 5 tightens or loosens the string 3 wound to the winding pin 8 when the knob 6 is turned.

A plate 11 extends diagonally downward from the front surface of the housing 7. The plate 11 includes a hole 12 for restricting rotation of the housing 7. The sleeve 13 of the housing 7 is inserted through the head 2 so that the winding pin 8 extends frontward from the head 2. Thus, each winding pin 8 is arranged on the front surface of the head 2. Referring to FIG. 1, each tuning device 5 is fixed to the head 2 by fastening a hexagonal nut 10, which is fitted to the associated winding pin 8 from the front side, with the female thread 14 of the sleeve 13. Further, a screw (not shown) is inserted in the hole 12 of each plate 11 from the rear side and fastened to the rear surface of the head 2 in order to restrict rotation of the tuning device 5 with respect to the head 2.

As shown in FIGS. 1 to 4, each knob 6 includes a large diameter portion 15 and a small diameter portion 16, which are cylindrical. The small diameter portion 16 is coaxial with the large diameter portion 15 and the worm 7a. A plurality of tool holes 18 are formed in the large diameter portion 15 at predetermined angular intervals around the small diameter portion 16. Each tool hole 18 extends parallel to the rotation axis c of the knob 6 and through the large diameter portion 15. In the preferred embodiment, eight equally spaced tool holes 18 are formed in the large diameter portion 15. A fitting hole 19 is formed in the central portion of the knob 6. The fitting hole 19 vertically extends through the small diameter portion 16 and the large diameter portion 15.

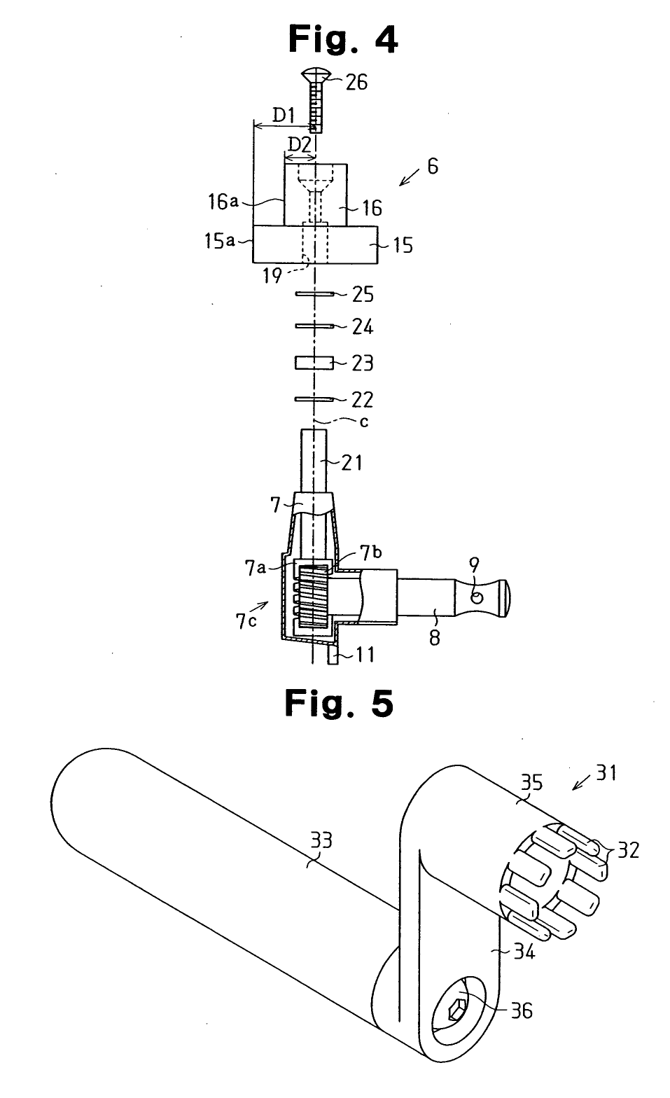

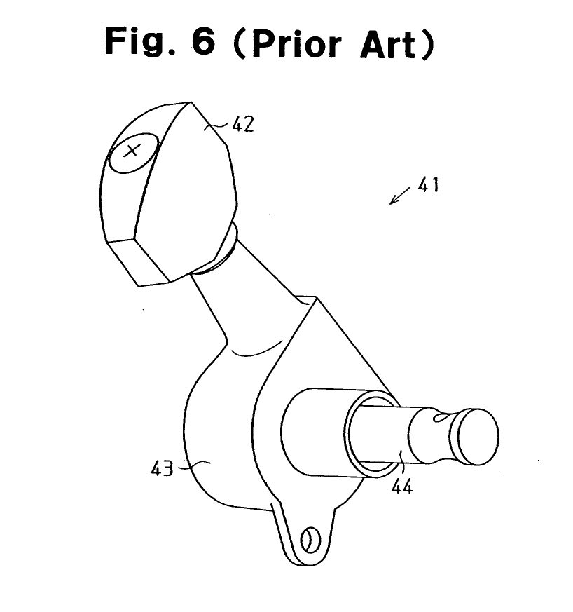

Referring to FIG. 4, an attachment shaft 21, which is connected to the worm 7a, is rotatably supported in the housing 7. The attachment shaft 21 projects upward from the housing 7 in a direction perpendicular to the winding pin 8.

A plurality of (four in the present embodiment) washers 22, 23, 24, and 25 are fitted in the fitting hole 19 of the knob 6 from the side of the large diameter portion 15. A screw 26 is inserted in the fitting hole 19 from the side of the small diameter portion 16. The screw 26 is extended through the washers 22, 23, 24, and 25 and fastened to a female thread formed in the attachment shaft 21. In this manner, the screw 26 fixes the knob 6 to the attachment shaft 21 so that the knob 6 does not fall off from the attachment shaft 21.

The attachment shaft 21 and the fitting hole 19 in the large diameter portion 15 have a generally elliptic cross-section. Accordingly, when the attachment shaft 21 is fitted in the fitting hole 19, independent rotation of the knob 6 relative to the attachment shaft 21 is restricted. Thus, the attachment shaft 21 rotates integrally with the knob 6.

The peripheral surface of the large diameter portion 15 and the small diameter portion 16 are gripped by one's fingers for turning. The peripheral surface of the large diameter portion 15 defines a first operation portion 15a, and the peripheral surface of the small diameter portion 16 defines a second operation portion 16a. In the preferred embodiment, the large diameter portion 15 has a radius D1 of 10 mm (a diameter of 20 mm) and a thickness of 6 mm. The small diameter portion 16 has a radius D2 of 5 mm (a diameter of 10 mm) and a thickness of 10 mm. Thus, the large diameter portion 15 has an outer diameter that is slightly larger than the diameter of a typical knob in the prior art (15 to 18 mm), and the small diameter portion 16 has an outer diameter that is slightly smaller than the diameter of a typical knob in the prior art. The distance between the rotation axis c of the knob 6 and the peripheral surface of the large diameter portion 15 is greater than the distance between the rotation axis c of the knob 6 and the peripheral surface of the small diameter portion 16. In other words, the distance between the first operation portion 15a and the rotation axis c of the knob 6 is greater than the distance between the second operation portion 16a and the rotation axis c.

In the tuning device 5, when the knob 6 is gripped and turned by one's fingers, the turning of the knob 6 rotates the attachment shaft 21. This, in turn, rotates the winding pin 8 by means of the worm screw mechanism 7c. Thus, the tuning device 5 is used to change the winding amount of the string 3 on the winding pin 8 and adjust the tension of the string 3.

The rotational movement amount of the small diameter portion 16 required to complete one rotation of the winding pin 8 is less than that of the large diameter portion 15. That is, the circumference of the small diameter portion 16 is shorter than that of the large diameter portion 15. Thus, if the small diameter portion 16 and the large diameter portion 15 were to be turned to rotate the winding pin 8 by the same amount when tightening (or loosening) the string 3, the rotational angle of the winding pin 8 would be changed more by turning the small diameter portion 16, of which rotational movement amount is small. Thus, the small diameter portion 16 is turned to efficiently perform tightening (or loosening). For example, when the string 3 is loose and rough adjustment of the key is still necessary, tension should be quickly applied to the string 3. In such a case, the small diameter portion 16 is gripped with one's fingers and rotated to wind the string 3 and efficiently perform tuning.

The outer diameter of the large diameter portion 15 is two times greater than that of the small diameter portion 16. Thus, if the small diameter portion 16 and the large diameter portion 15 were to be turned to rotate the winding pin 8 by the same amount, the rotational movement amount of the large diameter portion 15 would be two times greater than that of the small diameter portion 16. If the rotational movement amount of the large diameter portion 15 and the small diameter portion 16 were to be the same, the rotation of the winding pin 8 relative to the rotational movement amount of the large diameter portion 15 would be less than the rotation of the winding pin 8 relative to the rotational movement amount of the small diameter portion 16. Thus, when finely adjusting the pitch during the final tuning stage, the first operation portion 15a is rotated to accurately and easily perform tuning.

An exclusive winding tool 31 is used when, for example, changing the string 3, to turn the knob 6 many times and wind or unwind the string 3. As shown in FIG. 5, the winding tool 31, which is referred to as a winder, includes a plurality of projections 32, a cylindrical handle 33, and a connector 34. The connector 34 connects the projections 32 and the handle 33 in a crank-like manner. A cylindrical support 35 is formed on the distal end of the connector 34. The projections 32 extend from the distal end of the support 35 parallel to the axis of the support 35. The projections 32 are slightly smaller than the tool holes 18 of the knob 6 so that the projections 32 are insertable in the tool holes 18. In the present invention, eight projections 32 are formed at equal angular intervals in the same manner as the tool holes 18. A screw 36 is inserted in the basal end of the connector 34 and fastened with the handle 33 to connect the connector 34 and the handle 33 in a manner enabling relative rotation.

The handle 33 is turned about the support 35 with the projections 32 fitted in the corresponding tool holes 18 to turn the knob 6. Further, when winding or unwinding the string 3, the winding pin 8 is rotated more quickly and efficiently by gripping and turning the handle 33 with one's hand than when gripping and directly turning the knob 6 with one's fingers.

The preferred embodiment has the advantages described below.

(1) The knob 6 includes the large diameter portion 15 and the small diameter portion 16, which are coaxial. The peripheral surface of the large diameter portion 15 defines a first operation portion 15a, and the peripheral surface of the small diameter portion 16 defines a second operation portion 16a. Thus, when, for example, changing the string 3, the second operation portion 16a is used to quickly tighten or loosen the string 3. The first operation portion 15a is used to finely adjust the tension of the string 3. In this manner, the operation portions 15a and 16a are used in a different manner to perform tuning efficiently and easily.

(2) The large diameter portion 15 and the small diameter portion 16 are cylindrical. Thus, when gripping and turning the operation portions 15a and 16a, the wrist does not have to be turned back and may constantly be held at the same angle. Thus, with the tuning device 5, the string 3 is finely adjusted without the torque applied to the knob 6 being changed depending on the angular position of the knob 6.

(3) Each operation portion 15a and 16a has a circular cross-section. Thus, the torque applied to the knob 6 is constant regardless of the angular position of the knob 6. This enables the tuning device 5 to accurately and finely adjust the tension of the string 3.

(4) The knob 6 is fitted to the attachment shaft 21, and the screw 26 prevents the knob 6 from falling off from the attachment shaft 21. In other words, each knob 6 may be attached to or detached from the associated attachment shaft 21 by fastening or unfastening a single screw, and the knob 6 may be used compatibly with other knobs 6. Thus, the knob of a conventional tuning device may easily be replaced by the knob 6 of the preferred embodiment.

(5) The diameter of the small diameter portion 16 is slightly smaller than the diameter of a typical knob in the prior art. Thus, there is more space between neighboring small diameter portions 16 than between typical knobs in the prior art. Thus, when performing tuning with the second operation portion 16a, the tuning device 5 prevents one's fingers from being interfered with by the small diameter portion 16 of other knobs 6. This improves operability.

(6) The large diameter portion 15 includes the tool holes 18, into which the projections 32 of the winding tool 31 are inserted. Thus, tuning is efficiently performed with the tuning device 5 by using the winding tool 31. Further, insertion of the projections 32 into the tool holes 18 easily connects the knob 6 and the winding tool 31.

(7) When using the winding tool 31, the peripheral surface of the knob 6 is not held by the tool. This prevents abrasion of the peripheral surface of the knob 6 that may be caused by continuous usage of the winding tool and also prevents accidental scratching of the peripheral surface of the knob 6.

It should be apparent to those skilled in the art that the present invention may be embodied in many other specific forms without departing from the spirit or scope of the invention. Particularly, it should be understood that the present invention may be embodied in the following forms.

The large diameter portion 15 and the small diameter portion 16 may have a polygonal or equilaterally polygonal shape and may be, for example, hexagonal or octagonal. In such a case, the distance between the rotation axis c and the first operation portion 15a, which is defined by the polygonal and peripheral surface of the large diameter portion 15, must be greater than the distance between the rotation axis c and the second operation portion 16a, which is defined by the polygonal and peripheral surface of the small diameter portion 16. In the same manner as the preferred embodiment, the first operation portion 15a, which is located closer to the winding pin 8 than the second operation portion 16a, is used for fine adjustment.

The tool holes 18 may be eliminated. In such a case, advantages (1) to (5) are still obtained. Further, the winding tool 31 may be changed to any type of a known winding tool that holds, for example, the large diameter portion 15.

The large diameter portion 15 and the small diameter portion 16 of the knob 6 may be knurled. In such a case, the knurled large and small diameter portions 15 and 16 prevent one's fingers from slipping when the knob 6 is gripped.

Any type of musical instrument having a winding tuning device may be used in lieu of the guitar 1. Further, the tuning device 5 may be a direct winding device. That is, the worm screw mechanism 7c and the housing 7 may be eliminated, and each knob 6 may be attached to the rear end of the winding pin 8.

The present examples and embodiments are to be considered as illustrative and not restrictive, and the invention is not to be limited to the details given herein, but may be modified within the scope and equivalence of the appended claims.

What is claimed is:

1. A tuning device for tuning a musical instrument having a string, the tuning device comprising:
a winding pin for winding an end of the string;
a knob, connected to the winding pin, in which the knob is turned to rotate the winding pin and tune the instrument, the knob including a peripheral surface and an axis;
a first operation portion defined on the peripheral surface of the knob; and
a second operation portion defined on the peripheral surface of the knob and arranged coaxial to the first operation portion, the first operation portion being arranged closer to the winding pin than the second operation portion, where distance between the first operation portion and the axis of the knob is greater than that between the second operation portion and the axis of the knob.

2. The tuning device according to claim 1, further comprising a worm screw mechanism, wherein the worm screw mechanism includes:
a worm connected to the knob; and
a worm wheel connected to the winding pin and meshed with the worm.

3. The tuning device according to claim 1, wherein the knob includes:
a cylindrical large diameter portion including a peripheral surface defining the first operation portion; and
a cylindrical small diameter portion having a diameter that is smaller than that of the large diameter portion and including a peripheral surface defining the second operation portion.

4. The tuning device according to claim 3, wherein the knob includes a plurality of holes formed in the large diameter portion around the small diameter portion and extending parallel to the axis of the knob.

5. A musical instrument comprising:
a string;
a tuning device including a winding pin for winding an end of the string;
a knob, connected to the winding pin, in which the knob is turned to rotate the winding pin for tuning, the knob including a peripheral surface and an axis;
a first operation portion defined on the peripheral surface of the knob; and
a second operation portion defined on the peripheral surface of the knob and arranged coaxial to the first operation portion, the first operation portion being arranged closer to the winding pin than the second operation portion, where distance between the first operation portion and the axis of the knob is greater than that between the second operation portion and the axis of the knob.

6. A knob for a tuning device for tuning a musical instrument having a string, the tuning device including a winding pin for winding an end of the string, and the knob being connectable to the winding pin for rotating the winding pin and adjusting string tension, the knob comprising:
a peripheral surface and an axis;
a first operation portion defined on the peripheral surface of the knob; and
a second operation portion defined on the peripheral surface of the knob and arranged coaxial to the first operation portion, the first operation portion being arranged closer to the winding pin than the second operation portion, where distance between the first operation portion and the axis of the knob is greater than that between the second operation portion and the axis of the knob.

7. A winding tool for use with a tuning device for tuning a musical instrument having a string, the tuning device including a winding pin for winding an end of the string, and a knob, connected to the winding pin, the knob having an axis, in which the knob is turned to rotate the winding pin and adjust string tension, the tuning device including:
a cylindrical large diameter portion arranged on the knob, the large diameter portion having a peripheral surface;
a cylindrical small diameter portion arranged on the knob and having a diameter that is smaller than that of the large diameter portion, the small diameter portion having a peripheral surface;
a first operation portion defined on the peripheral surface of the large diameter portion;
a second operation portion defined on the peripheral surface of the small diameter portion and arranged coaxial to the first operation portion, in which the first operation portion is arranged closer to the winding pin than the second operation portion, where distance between the first operation portion and the axis of the knob is greater than that between the second operation portion and the axis of the knob; and
a plurality of holes formed in the large diameter portion and extending parallel to the axis of the knob;
the winding tool comprising:
a support including projections that are respectively insertable into the holes of the large diameter portion;
a handle for manually grasping; and
a connector for connecting the projections and the handle for forming a crank, wherein the handle is operated in a state in which the projections are inserted into the corresponding holes to rotate the support and the knob integrally with each other.
